(19) United States
(12) Patent Application Publication
(10) Pub. No.: US 2006/0165216 A1
(43) Pub. Date: Jul. 27, 2006

(54) Method for detection of micrometric and sub-micrometric images by means of irradiation of a mask or of a biological specimen with ionizing radiation

(76) Inventors: Giuseppe Baldacchini, Grottaferrata (IT); Rosa maria Montereali, Grottaferrata (IT); Francesca Bonfigli, Ostia (IT); Francesco Flora, Montecompatri (IT); Angelo Pace, Colleferro (IT); Anatoly Yakovlevich Faenov, Moscow (RU); Tatiana Pikuz, Moscow (RU); Lucia Reale, Monteporizio Catone (IT)

Correspondence Address: MITCHELL P. BROOK;C/O LUCE, FORWARD, HAMILTON & SCRIPPS LLP, 11988 EL CAMINO REAL, SUITE 200, SAN DIEGO, CA, 92130, US

(21) Appl. No.: 10/519,815

(22) PCT Filed: Jun. 27, 2003
(86) PCT No.: PCT/IT03/00404

§ 371 Date: Jul. 25, 2005

(30) Foreign Application Priority Data
Jul. 2, 2002 (IT) TO2002A000575

(51) Int. Cl. G21K 7/00

(52) U.S. Cl. 378/43

(57) ABSTRACT

Described herein is a method for detection of micrometric and sub-micrometric images with high resolution and high dynamics contrast, and suited for enabling microradiography, x-ray microscopy and the production of coloured configurations in dielectric materials. The method consists of radiation of energy comprised between 20 and 2000 eV for irradiating a mask or a biological specimen and use of a detector consisting of LiF in the form of a crystal or a film. The power of the radiation released in the LiF detector during exposure is preferably ≧10 mW/cm³.

### TECHNICAL FIELD

The present invention relates to a method for detection of micrometric and sub-micrometric images by means of irradiation of a mask or of a biological specimen with ionizing radiation.

### BACKGROUND ART

Known for some time is the use of ionizing radiation of energy comprised between 20 and 2000 eV, generally referred to as “soft x-rays”, in the field of microradiography and x-ray microscopy (Bollanti et al., Il Nuovo Cimento 20D, pp. 1685-1701, 1998).

In said techniques, normal photographic-emulsion-based photographic plates prove ineffective on account of the excessive size of the grains of the emulsion itself as compared to the micrometric and sub-micrometric details, which are to be observed on the specimen.

For this reason, as detectors specific photosensitive plastics referred to as “photoresists” are used, of which the most widely utilized is represented by PMMA.

Even though detectors of a photoresist type enable viewing of the micrometric and sub-micrometric details, the radiographic images obtained are characterized by poor dynamics of contrast. In fact, the photoresist does not respond where the dose of energy is too low, and is saturated completely where the energy dose is too high. In technical terms, it may be said, for example, that the photoresist of a PMMA type enables 5-to-6-bit images to be obtained.

Another disadvantage regarding the use of the photoresist concerns the need for developing the photoresist itself using certain substances, such as alcohol of an MIBK type, capable of removing the parts of polymer impinged upon by the radiation. Said operation of development causes a loss of spatial definition of the image on account of the inevitable lateral corrosion of the polymer.

A different type of x-ray microscopy is projection microscopy, in which the image of the specimen is projected on the detector with high enlargement, for example approximately 1000 times, and as detector a charge-coupled device (CCD) is used. For this type of microscopy, plasma lasers do not have a sufficient mean power, and a powerful monochromatic source is therefore required, such as a synchrotron-light source, with the obvious drawbacks due in particular to the high costs and to the inevitable encumbrance that the use of the synchrotron involves.

Turning our attention to another area of the art, and in particular to the area regarding the realization of micro-optical devices, there has for some time been felt the need to colour just some well-defined areas (hereinafter referred to as configurations) of a crystal or film of halogenide with the highest spatial definition possible. In this regard, it has for some time been known that ionizing radiation may give rise to a colouring of dielectric materials, for example LiF crystals, caused by the formation of punctiform lattice defects which, on account of the colouring produced, are called “colour centres”. Some colour centres emit an intense luminescence if excited by a radiation of wavelength lower than that of emission.

It is moreover known that the density of the colour centres generated in a crystal is approximately proportional to the square root of the dose of radiation absorbed and, should the radiation itself have a power higher than a given threshold value, given the same dose, the aforesaid density of the colour centres increases in a way that is directly proportional to the power (J. H. Schulman and W. D. Compton “Color Centers in Solids”, Pergamon Press, 1962).

In order to obtain a well-defined high-resolution colouring, a not very penetrative ionizing radiation has been used, such as low-energy electron beams. Such a technique suffers from the drawback of presenting particularly long execution times. In fact, depositing of the space charge of the electrons, in particular at the end of their path, entails an extreme slowness in writing high-resolution configurations.

There was thus been felt the need to make available a method for detection of high-definition micrometric and sub-micrometric images, together with high dynamics of contrast and particularly short execution times, which could find application both in techniques of microradiography and x-ray microscopy and in the realization of configurations in alkaline-halogenide crystals or films.

### DISCLOSURE OF INVENTION

The present invention relates to a method for detection of micrometric and sub-micrometric images by means of irradiation of a mask or of a biological specimen with ionizing radiation, characterized in that said ionizing radiation has an energy comprised between 20 and 2000 eV, and in that it comprises a detector consisting of LiF designed to receive said ionizing radiation.

According to a preferred embodiment of the method of the present invention, said ionizing radiation releases in the detector a power higher than or equal to 10 mW/cm³.

Preferably, the method according to the present invention envisages that said ionizing radiation will be generated by a plasma-laser system, which comprises a pulsed excimer laser and a target material.

Preferably, the method according to the present invention envisages that the detector will consist of a LiF film.

### BRIEF DESCRIPTION OF THE DRAWINGS

The ensuing examples are to be considered non-limiting, and are provided with a purely illustrative purpose for a better understanding of the invention. In addition, reference will be made to the following figures:

FIG. 1 is a schematic illustration of a device for making microradiographs or colour configurations in crystals or on films by means of irradiation of soft x-rays;

FIG. 2 is an image of luminescence of a LiF crystal treated with soft x-rays according to the diagram of FIG. 1;

FIG. 3 is a detail of a wing of a dragon fly x-rayed on LiF (a) and on photoresist made of PMMA (b); and

FIG. 4 is the radiograph of a polypropylene phantom having a thickness of 0, 1, 2, 3 μm, obtained (according to the diagram designated by (a)) on 2-μm thick LiF film (b) and on photoresist made of PMMA (c, d).

### BEST MODE FOR CARRYING OUT THE INVENTION

### EXAMPLES

### Example 1

### Micrometric Contact Detection of a Mask on a LiF Crystal

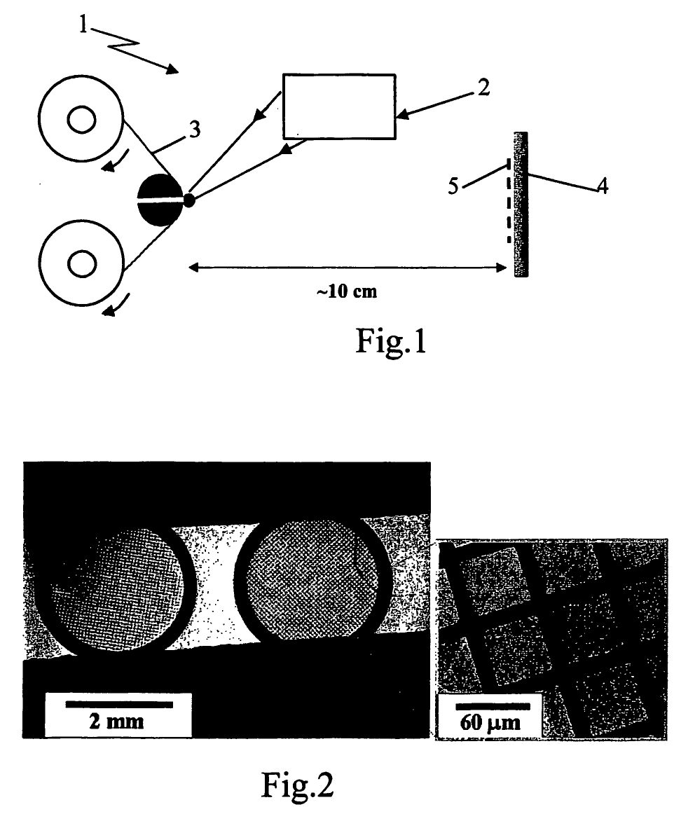

As illustrated schematically in FIG. 1, a device 1 was built for contact detection of masks or biological specimens.

Specifically, the device of FIG. 1 comprises a 1J—10 ns XeCl excimer laser designated as a whole by 2, a strip 3 of target material, preferably copper or iron, which, together with the excimer laser, constitutes the plasma-laser source, a LiF crystal or a LiF film 4 set at a distance of 10 cm from the plasma-laser source, and a mask 5 set in contact with the LiF crystal or the LiF film 4.

Using the device described above, microscopic detection of a grid having a diameter of 3 mm and a pitch of 60 μm was performed. The LiF crystal was treated with soft x-rays, the spectrum of emission of which was concentrated in the range of 20-200 eV (i.e., in the extreme ultraviolet—EUV), and generated with 1000 pulses on a target made of Fe using the laser of FIG. 1 functioning at 1 Hz. The laser used may be made to function at up to 100 Hz and is thus able to emit 1000 pulses in 10 seconds.

Given the extremely high absorption in the EUV, each shot deposits in the crystal a dose of 30 J/cm³, with a corresponding power of 3 GW/cm³.

In LiF specimens, the 1000 pulses were sufficient to generate an intense luminescence in the spectral range of the visible (green, yellow, red) by excitation with blue light.

FIG. 2 presents the corresponding image of luminescence observed with an optical microscope having a 40× lens. From FIG. 2 there clearly emerges the intense luminescence of the areas not shielded from the x-rays and the absence of luminescence in the areas in which the grid shaded the x-rays. In addition, there was obtained a transverse resolution of less than 1 μm, and the precision of the measurement was limited by the properties of the optical microscope used for obtaining the image of luminescence.

The lack of uniformity of the luminescence in FIG. 2 is due to the incomplete uniformity of the blue light generated by an Ar laser used for excitation of the luminescence and not by lack of uniformity in the density of the optically active colour centres.

From the example given above, it emerges clearly how, with the method according to the invention, it is possible to build micro-optical devices with a high resolution, over vast areas, and in times at least 100 times shorter than those afforded by electron-beam irradiation.

### Example 2

### Microradiography of a Biological Specimen on a LiF Film and on a Photoresist

Using the device illustrated in FIG. 1 and replacing the mask with a biological specimen, microradiography was performed of the wing of a dragon fly obtained on a LiF film and, for comparison, microradiography was performed of the other wing of the same insect on a photoresist made of PMMA. The two exposures were obtained simultaneously in the same experimental conditions by means of 1100 pulses on a target made of copper set at a distance of 10 cm from the biological specimen.

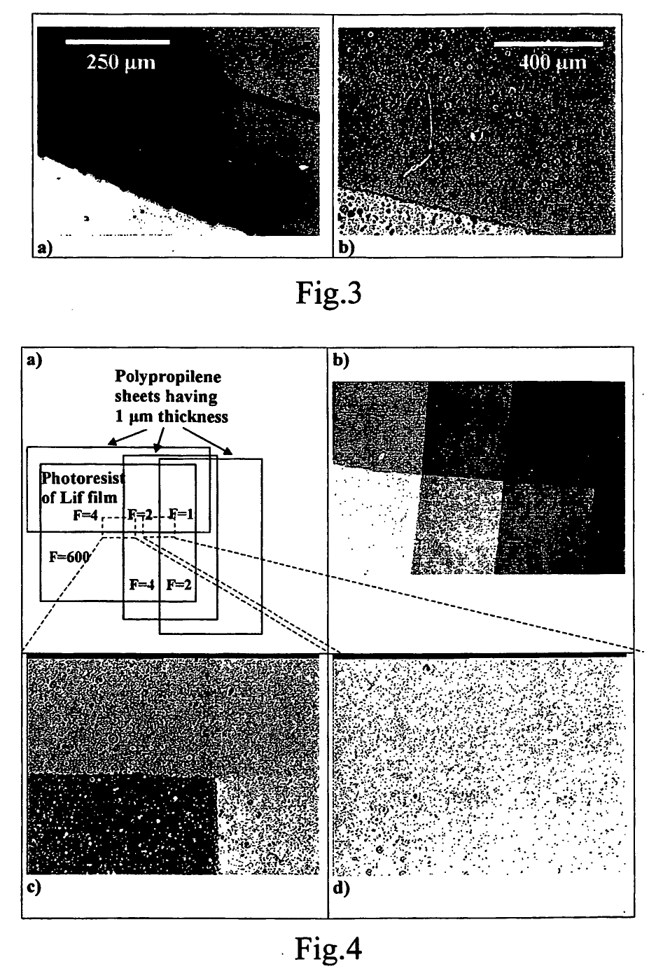

FIG. 3 presents the corresponding microradiographs observed at an optical microscope with 20× lens. In particular, the microradiography on PMMA was made with an operation of development for one minute in MIBK, and the observation at the atomic-force microscope (AFM) of the same PMMA did not enable images better than those presented in FIG. 3 to be obtained. From the comparison of the two microradiographs, it is evident how the peculiar performance of response of LiF enables a quality of image considerably higher than the one obtained on the photoresist. In fact, PMMA allows the internal structure of the wing to be only scarcely discerned and, furthermore, it is more vulnerable to the bombardment of the considerable amount of detritus emitted by the plasma-laser source, which is made up of particles of melted metal having a diameter ranging typically between 0.1 and 100 μm.

In particular, for the LiF film the dynamics of the image (number of shades of grey and hence number of bits of the image) is not limited by the characteristics of corrosion of the photoresist, which requires a mechanical reading of the information following upon development, but principally by the efficiency of formation of the aggregated luminescent centres in the LiF film in the conditions of dose and of power used in the x-ray irradiation.

### Example 3

### Microradiography of a Ploypropylene Phantom of Varying Thickness on a LiF Film and on a Photoresist

Using the device illustrated in FIG. 1, radiography was performed on a polypropylene phantom having a thickness of 0, 1, 2, 3 μm on a LiF film and, for comparison, on a photoresist made of PMMA.

The radiograph was obtained by means of 1100 pulses on a target made of copper set at a distance of 10 cm from the polypropylene phantom. The fluences that reached the detector made of LiF or the detector made of PMMA in the different areas corresponding to the different thicknesses of the phantom were, respectively, 600 mJ/cm², 4 mJ/cm², 2 mJ/cm², and 1 mJ/cm², as indicated in the quadrant (a) of FIG. 4.

From the comparison of the quadrants (b), (c) and (d) of FIG. 4, it may be noted that on the LiF detector (quadrant (b)) there are readily recognizable the “impressions” of x-ray radiation corresponding to all the different values of dose, and that on the PMMA (quadrants (c) and (d)) only the area with direct exposure corresponding to a thickness of 0 μm is clear, whereas the others may be easily confused with one another, even if analysed at the atomic-force microscope.

In the light of Example 1, it is evident how the method according to the present invention enables very high-resolution configurations to be obtained and in a length of time at least 100 times shorter than that required, given the same resolution, by techniques with irradiation using electron beams.

Said advantages can be directly connected to the possibility of irradiating, at the same moment, an extended portion of mask.

In the light of Examples 2 and 3, it is evident how the method according to the present invention enables micrometric and sub-micrometric images to be obtained having a definition and a dynamics of contrast that are clearly higher than those obtained using the methods of the known art.

It is, in fact, important to emphasize both that the transverse resolution is not limited by the grain of the photographic emulsion, which is of the order of a few micron, and that the dynamics is not limited by the properties of development of the negative and hence enables 8 to 12 bit images to be obtained unlike the 5 to 6 bit images obtained using the PMMA photoresist.

It has been found that the aforesaid advantages are more evident if the LiF is used in the form of a film instead of a crystal. The performance of the LiF film as detector may be continuously improved by appropriately controlling the parameters of growth of the film itself, which, in turn, influence the morphological, structural and optical characteristics of the material deposited.

As compared to the known art regarding the techniques of microradiography or x-ray microscopy, another important advantage of the method according to the present invention derives from the fact that the reading of the detector takes place by luminescence, i.e., by means of a technique by several orders of magnitude more sensitive than any other system that is based upon absorption, such as photographic plates or photoresists.

The LiF crystal or LiF film may be read using an optical microscope or a confocal and/or near-field microscope (SNOM—scanning near-field optical microscope). As is obvious, using the method according to the present invention no operation of development is envisaged, as occurs, instead, in the case where the detector is a photoresist, and this constitutes an advantage both for reasons linked to the resolution and for reasons linked to the praticality of the method itself.

In addition, it is important to note that both the short duration of the application and the high dynamics of contrast may be further optimized by increasing the power of the ionizing radiation.

Finally, a possible modification of the device illustrated in FIG. 1 consists in the use of multilayer mirrors for reproducing in projection the mask or the biological specimen on the LiF crystal or on the LiF film. In this case, the transverse resolution is no longer limited by the effects of diffraction that occur in the space between the mask or biological specimen and the LiF detector. This enables a reduction of the resolution to values lower than 100 nm, but requires exclusive use of the energies of the x-rays that can be reflected effectively by the multilayer mirrors for x-rays (typically 90 eV), the estimated penetration of which (approximately 30 nm) is compatible with the thicknesses of LiF film.

The method according to the present invention finds particular application for carrying-out x-ray microscopy and

1. A method for detection of micrometric and sub-micrometric images by means of irradiation of a mask or of a biological specimen with ionizing radiation, characterized in that said ionizing radiation has an energy comprised between 20 and 2000 eV, and in that it comprises a detector consisting of LiF designed to receive said ionizing radiation.

2. The method according to claim 1, characterized in that said ionizing radiation deposits on said detector a power ≧10 mW/cm³.

3. The method according to claim 1 or claim 2, characterized in that said ionizing radiation is generated by a plasma-laser system.

4. The method according to claim 3, characterized in that said plasma-laser system comprises a pulsed excimer laser and a strip of target material.

5. The method according to claim 4, characterized in that said pulsed excimer laser is an XeCl laser.

6. The method according to any one of the preceding claims, characterized in that said detector is a LiF film.

7. The method according to any one of the preceding claims, characterized in that said mask or said biological specimen is set in contact with said LiF detector.

8. The method according to any one of claims 1 to 6, characterized in that it uses multilayer mirrors designed to reproduce in projection said mask or said biological specimen on said detector.

9. A device for detection of micrometric and sub-micrometric images for irradiation of a mask or of a biological material with ionizing radiation, characterized in that it uses a method according to any one of the preceding claims.

10. The device according to claim 9, characterized in that it enables micro-radiography or x-ray microscopy.

11. The device according to claim 9, characterized in that it enables configurations for optical devices to be obtained.
